(19) United States
(12) Patent Application Publication
(10) Pub. No.: US 2026/0253776 A1
(43) Pub. Date: Aug. 27, 2026

(54) ELECTROMAGNET WITH IMPEDANCE ELEMENT

(71) Applicant: SVM Schultz Verwaltungs-GmbH & Co. KG, Memmingen (DE)

(72) Inventors: Robin Gruber, Benningen (DE); Ralph Wassermann, Holzgünz (DE)

(21) Appl. No.: 19/532,610

(22) Filed: Feb. 6, 2026

(30) Foreign Application Priority Data
Feb. 25, 2025 (DE) 10 2025 107 150.0

(51) Int. Cl. H01F 7/08; H01F 7/16; H01F 27/28

(52) U.S. Cl. CPC H01F 7/081; H01F 7/1607; H01F 27/288; H01F 2007/086

(57) ABSTRACT

An electromagnet, traversed by a longitudinal axis, has an armature arranged longitudinally movable along a stroke path, and a shielding element arranged in a magnetic circuit. The shielding element extends along the longitudinal axis and forms at least one impedance changing means on the stroke path, which defines an impedance change position for the armature, at which the electrical impedance can change as the armature approaches and/or passes the impedance change position, compared with a reference position on the stroke path of the armature.

### CROSS-REFERENCE TO RELATED APPLICATIONS

This non-provisional application claims the benefit of, and priority to, German Patent Application No. 10 2025 107 150.0, filed on February 25, 2025, which is incorporated by reference in its entirety.

### FIELD OF THE DISCLOSURE

The present disclosure generally relates to an electromagnet.

### BACKGROUND

An electromagnet can have a core and an armature, for example a linear magnet. The electromagnet can have a sensor system for detecting the armature position that can be determined by way of the electric impedance of the coil. Here, the impedance can be measured before and after an armature’s movement in order to assess, from the difference between the measured values, whether the armature has been adjusted to its desired position.

However, in the case of small armature movements, the impedance difference is small and assessment of the desired adjusting movement is associated with an unsatisfactorily large degree of uncertainty or is not possible. Moreover, the coil-related impedance values are heavily dependent on temperature, geometry, and material properties, and therefore, detection and assessment of the armature position remain susceptible to improvement in this regard as well.

### SUMMARY

An electromagnet, having a longitudinal axis, includes an armature longitudinally movable along a stroke path, and a shielding element arranged in a magnetic circuit. The shielding element extends along the longitudinal axis and forms at least one impedance changing means on the stroke path, which defines an impedance change position for the armature.

### BRIEF DESCRIPTION OF THE DRAWINGS

For a more complete understanding of this disclosure, reference is now made to the following description, taken in conjunction with the accompanying drawings, in which:

FIG. 1 illustrates a cross-sectional view of an electromagnet;

FIG. 2 illustrates a detailed view of an electromagnet with the armature in the reference position;

FIG. 3 illustrates a detailed view of an electromagnet with the armature in the impedance change position, and

FIG. 4 illustrates a detailed view of a shielding element with a plurality of impedance changing means.

### DETAILED DESCRIPTION

In the figures, elements that are the same or correspond to one another are each denoted by the same reference signs and are therefore not described repeatedly, unless it is expedient to do so. To avoid repetition, features that have already been described are not described again and can be applied to all elements that have the same or corresponding reference signs, unless explicitly excluded. The disclosures in the description as a whole can be applied mutatis mutandis to identical parts with the same reference signs or the same component designations. Moreover, the position indications, such as top, bottom, or laterally etc., used in the description refer to the figure currently being described and explained and, if there is a change in position, they should be applied mutatis mutandis to the new position. In addition, individual features or combinations of features from the different exemplary embodiments shown and described may represent independent solutions that are inventive or in accordance with the disclosure.

Disclosed is an electromagnet. The electromagnet has an armature that is longitudinally movable along a stroke path, and a shielding element arranged in a magnetic circuit and extending along a longitudinal axis of the electromagnet, forming at least one impedance changing means on the stroke path, which defines an impedance change position for the armature, at which the electrical impedance can change or does change as the armature approaches and/or passes, compared with a reference position on the stroke path of the armature.

The disclosure is based on the concept that an impedance spread between the two positions can be achieved by means of the shielding element. During a stroke movement of the armature in the direction of the impedance change position, the distance between the armature and the impedance change position is reduced or even eliminated, and a magnetic short circuit is formed. As the armature approaches and/or passes the impedance change position, the electromagnet then produces the magnetic short circuit in precisely this defined impedance change position of the armature. The magnetic short circuit spreads the impedance values in the two positions (reference position and impedance change position) to a considerable extent. As a result, the armature stroke position can be determined very accurately and reliably. The impedance in the reference position is lower or higher than in the impedance change position. When the armature reaches the impedance change position, an air gap between the armature and the impedance changing means is closed. This serves to produce the magnetic short circuit. By means of the disclosure, position detection can be improved considerably at the impedance change position.

The shielding element extends in the longitudinal direction into the stroke path and ends there. The longitudinal end or front end of the shielding element is located on the stroke path. The shielding element is arranged on the outer circumference with respect to the armature. The impedance changing means can be the longitudinal end or front end of the shielding element. The longitudinal end can be annular and can extend around the armature space. It is thereby possible to achieve an even greater impedance spread. The shielding element is arranged on the outer circumference with respect to the stroke space. The reference position can be at a point along the stroke path at which the armature is at a distance from the shielding element. There can be a reference impedance at the reference position. The impedance at the/each impedance change position differs from the reference impedance, in aspects, by an impedance difference.

Sensing of the armature position is accomplished by measuring the impedance of the coil. Measurement can be accomplished by means of a control block of the electromagnet. The impedance spread by means of the shielding element requires only a very slight extra structural outlay as compared with alternative possibilities for sensing, e.g. Hall-effect sensors.

In aspects of the electromagnet, the shielding element can be a sleeve. A sleeve is very low-cost, easy to install, and furthermore requires only a very small installation space. In aspects, the shielding element is rotationally symmetrical with respect to the longitudinal axis. The shielding element has the longitudinal axis as a central axis of rotation and can still look the same when rotated by a defined angle [360°/n] about said axis of rotation. Additionally, or alternatively, the shielding element is rotationally symmetrical, for example, a rotation through any desired angle with respect to the longitudinal axis has the effect that the shielding element still looks the same. The shielding element can be a body of revolution with respect to the longitudinal axis. As a result, the installation position in the circumferential direction is irrelevant. Moreover, a sleeve, in particular a symmetrical sleeve, avoids a magnetic transverse pull, which would have a negative effect on the armature. By virtue of the geometry of the sleeve, very tight structural tolerances can be maintained, and these in turn advantageously lead to a narrow spread of the impedance. The shielding element (e.g. the sleeve) can have an armature-side longitudinal end or front end, and, at the opposite end along the longitudinal axis, can have a core-side longitudinal end or front end.

In aspects, the shielding element can be a deep-drawn part. This is because it is then possible to produce it at very low cost. Even in this case, however, very tight structural tolerances can be maintained.

In aspects of the electromagnet, the shielding element can be in one piece. It can consist of a single piece. This avoids the joining of individual parts.

In aspects of the electromagnet, the shielding element can be arranged on the outer circumference of a pole tube. The armature can be supported in a sliding manner on the pole tube. It is advantageously possible to place the shielding element close to the armature, which serves to produce the magnetic short circuit.

In aspects of the electromagnet, the shielding element can be arranged on the inner circumference with respect to the coil form. This serves to facilitate assembly. Moreover, this location serves for the deliberate changing of the magnetic flux via the impedance change position.

In aspects of the electromagnet, the impedance difference between the (each) impedance change position and the reference position is at least 2 Ω. It has been found that, depending on the geometry and/or location of the shielding element and taking into account the various boundary conditions (desired sensing, installation space limits etc.), an impedance spread of at least 2 Ω can be achieved; alternatively, at least 4 Ω; alternatively, at least 6 Ω; or alternatively, at least 8 Ω. If there are several impedance change positions, the said impedance difference applies to each of the impedance change positions.

In aspects of the electromagnet, the impedance changing means can be a longitudinal end or front end of the shielding element. This is very simple in terms of construction but effective since the end of the shielding element is already sufficient to produce a short-induced impedance spread according to the disclosure.

In aspects of the electromagnet, the shielding element can comprise a plurality of impedance changing means. In aspects, the impedance changing means can be formed by jumps in material thickness. Each impedance changing means defines an impedance change position. In some aspects, one impedance changing means is formed by the longitudinal end or front end of the shielding element, and the other impedance changing means are formed by the jumps in material thickness. The impedance change positions can have different impedances. Since the impedance at each impedance changing means is different, the armature stroke position can be determined very accurately and reliably. In some aspects, a jump in material thickness is formed by the longitudinal end or front end of the shielding element. The different impedances can be determined by material thickness. The jumps in material thickness lead to the shielding element being stepped at the outer and/or inner circumference. In one embodiment, each jump in material thickness defines an annular offset.

In aspects of the electromagnet, the shielding element can have a material thickness in the range of from 0.15 mm to 1.0 mm; alternatively, from 0.15 mm to 35 mm. These dimensions have proved sufficient to achieve the desired effects. The smallest wall thickness can be referred to as the minimum wall thickness. The greatest wall thickness can be referred to as the maximum wall thickness.

In aspects of the electromagnet, one front end of the shielding element can be arranged at the level of the core and/or at the level of the longitudinal end of the coil form. This has the effect that the shielding element has a large longitudinal extent, which in turn leads to an improved impedance spread since, in the case of a larger overlap, the magnetic flux is advantageously diverted. The overlap can be achieved by means of the core and the shielding element. In addition, or as an alternative, the shielding element can have a longitudinal extent which ranges from 2 times to 8 times the stroke path; alternatively, from 2 times to 6 times the stroke path.

In aspects of the electromagnet, a front end of the shielding element can form an annular flange which extends radially inwards or radially outwards. This is conducive to easy and reliable assembly. The radially inner flange can rest against the core. The radially outer flange can rest against the coil form.

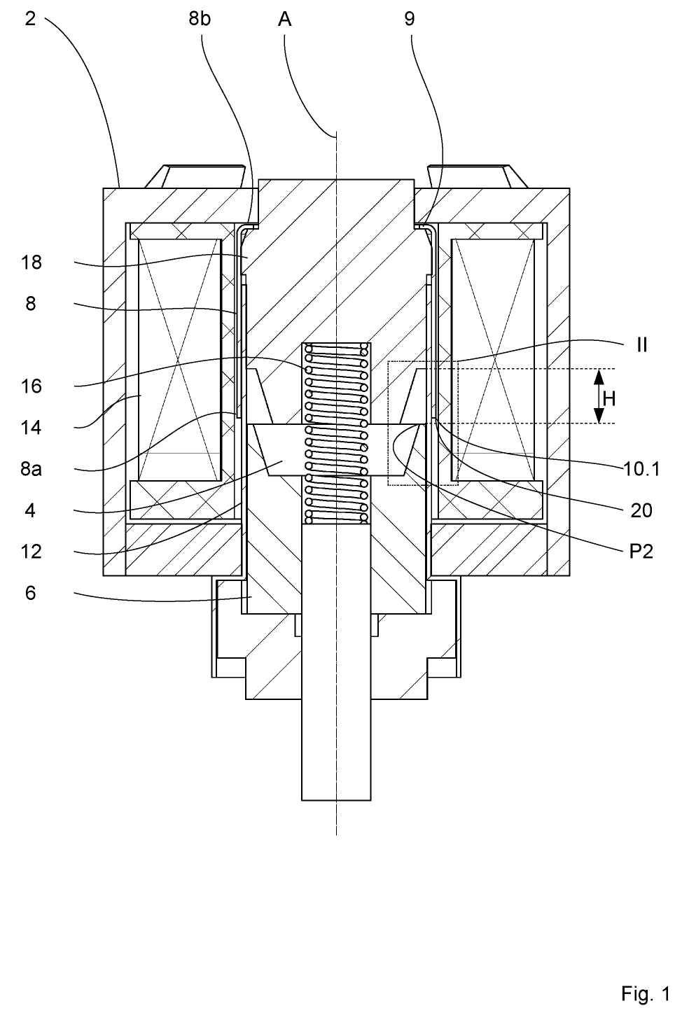

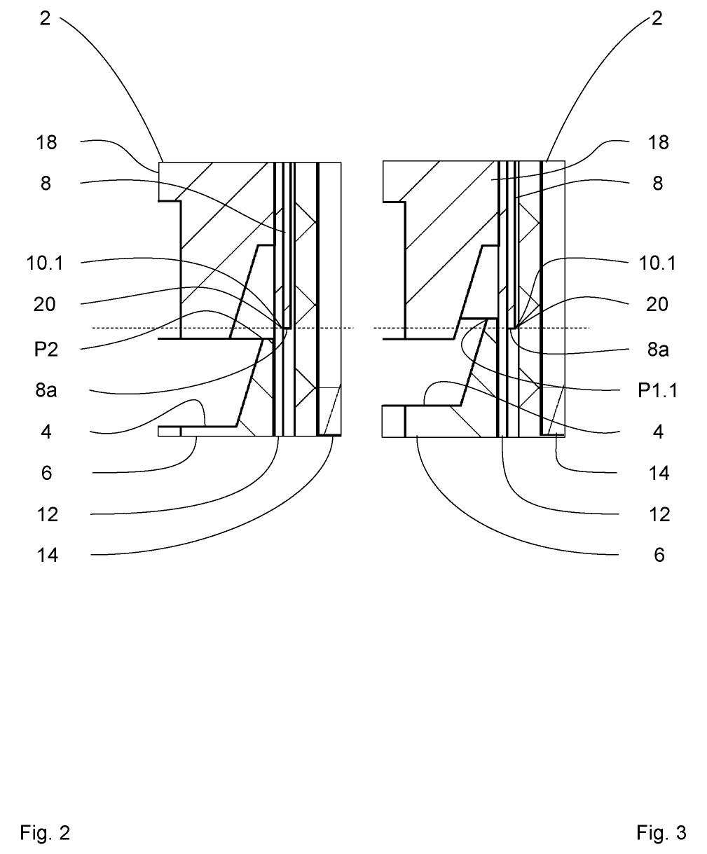

FIGS. 1 to 3 show an electromagnet 2 which is designed as a linear magnet. FIG. 2 shows the detail II from FIG. 1. FIG. 3 shows the same detail II with the armature 6 adjusted. The electromagnet 2 is traversed by a longitudinal axis A and comprises an armature space 4 and an armature 6, which is arranged in the armature space 4 in such a way as to be longitudinally movable along a stroke path H. At the outer circumference, the armature space 4 is delimited by a pole tube 12, which provides a sliding bearing for the armature 6. In addition, the electromagnet 2 comprises a coil form 14, which can be selectively energized to adjust the armature 6. A spring 16 biases the armature 6 into an end position. In addition, the electromagnet 2 has a core 18.

Furthermore, the electromagnet 2 comprises a one-piece shielding element 8, which consists of a ferromagnetic material, and is a deep-drawn part and a sleeve. The shielding element 8 is a body of revolution with respect to the longitudinal axis A. The shielding element 8 has an armature-side longitudinal end 8a, and, at the opposite end along the longitudinal axis, a core-side longitudinal end 8b. The core-side longitudinal end 8b forms an annular flange 9, which extends radially in-wards and rests against the core 18. The longitudinal extent of the shielding element 8 corresponds approximately to 3 times the stroke path H.

The shielding element 8 extends on the outer circumference with respect to the armature 6 along the longitudinal axis A into the stroke path H and ends there with its armature-side longitudinal end 8a. The core-side longitudinal end 8b is arranged at the level of the core 18 and at the level of the longitudinal end of the coil form 14. The shielding element 8 is arranged on the outer circumference of the pole tube 12 and on the inner circumference of the coil form 14 and located in the magnetic circuit.

In FIGS. 1 to 3, the shielding element 8 forms a single impedance changing means 10.1. The impedance changing means 10.1 is the armature-side longitudinal end 8a of the shielding element 8, which as it were forms a jump 20 in material thickness. The impedance changing means 10.1 is arranged on the stroke path H, and it can therefore be approached or passed by the armature 6. The impedance changing means 10.1 defines an impedance change position P1.1 for the armature. At the impedance change position P1.1, there is an impedance. A reference position P2 is defined at one point along the stroke path H at a distance from the shielding element 8. At the reference position P2, there is a reference impedance. There is an impedance difference between the impedance at the reference position P2 and the impedance change position P1.1.

When the armature 8 reaches the impedance change position P1.1, an air gap between the armature 8 and the impedance changing means 10.1 is closed, thereby producing a magnetic short circuit.

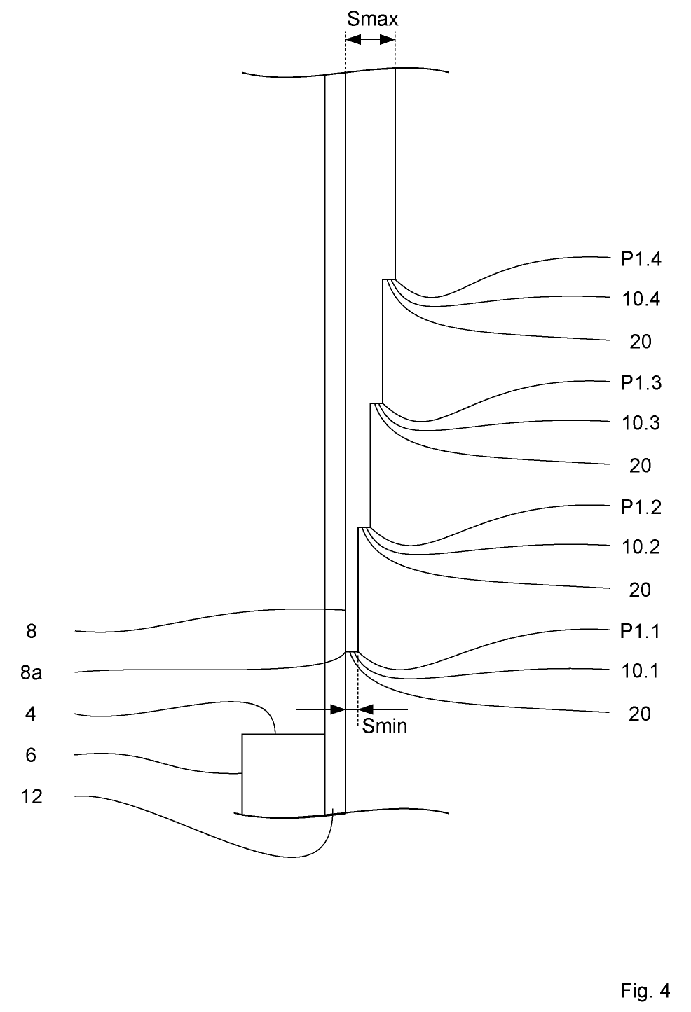

In FIG. 4, the shielding element 8 forms four impedance changing means 10.1, 10.2, 10.3, 10.4. Each impedance changing means 10.1, 10.2, 10.3, 10.4 is formed by a jump 20 in material thickness. The shielding element 8 is accordingly stepped on the outer circumference, wherein the jumps 20 in material thickness define annular offsets. Each impedance changing means 10.1, 10.2, 10.3, 10.4 defines an impedance change position P1.1, P1.2, P1.3, P1.4. The impedance change positions P1.1, P1.2, P1.3, P1.4 have different impedances and furthermore all have impedances that differ from the impedance at the reference position P2.

The material thickness of the shielding element 8 can be at least Smin, e.g. 0.15 mm, and at most Smax, e.g., 1.0 mm.

The disclosure is not restricted to one of the embodiments described above but can be modified in many different ways. All the features and advantages that emerge from the claims, the description and the drawing, including design details, spatial arrangements and method steps, may be essential to the disclosure either in themselves or in a wide variety of combinations.

All combinations of at least two features disclosed in the description, claims and/or the figures fall within the scope of the disclosure.

To avoid repetition, features disclosed in terms of devices should also be regarded as disclosed and claimable in terms of methods. Likewise, features disclosed in terms of methods should also be regarded as disclosed and claimable in terms of devices.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

### List of reference signs

2 electromagnet

4 armature space

6 armature

8 shielding element

8a longitudinal end

8b longitudinal end

9 annular flange

10.1 impedance changing means

10.2 impedance changing means

10.3 impedance changing means

10.4 impedance changing means

12 pole tube

14 coil form

16 spring

18 core

20 jump in material thickness

A longitudinal axis

H stroke path

P1.1 impedance change position

P1.2 impedance change position

P1.3 impedance change position

P1.4 impedance change position

P2 reference position

Smin minimum wall thickness

Smax maximum wall thickness

What is claimed is:

1. An electromagnet, which is traversed by a longitudinal axis, comprising:
an armature longitudinally movable along a stroke path; and
a shielding element arranged in a magnetic circuit and comprising a ferromagnetic material;
wherein the shielding element extends along the longitudinal axis and forms at least one impedance changing means on the stroke path, which defines an impedance change position for the armature.

2. The electromagnet according to claim 1, wherein an electrical impedance changes as the armature approaches the impedance change position, compared with a reference position on the stroke path of the armature.

3. The electromagnet according to claim 1, wherein an electrical impedance changes as the armature passes the impedance change position, compared with a reference position on the stroke path of the armature.

4. The electromagnet according to claim 1, wherein an electrical impedance can change as the armature approaches and passes the impedance change position, compared with a reference position on the stroke path of the armature.

5. The electromagnet according to claim 1, wherein the shielding element is a sleeve.

6. The electromagnet according to claim 1, further comprising a pole tube, wherein the shielding element is arranged on an outer circumference of the pole tube.

7. The electromagnet according to claim 1, further comprising a coil form, wherein the shielding element is arranged on an inner circumference with respect to a coil form.

8. The electromagnet according to claim 1, wherein an impedance difference between the impedance change position and a reference position is at least 2 Ω.

9. The electromagnet according to claim 1, wherein the at least one impedance changing means is a front end of the shielding element.

10. The electromagnet according to claim 1, wherein the shielding element comprises a plurality of impedance changing means.

11. The electromagnet according to claim 1, wherein the at least one impedance changing means is formed by jumps in a material thickness of the shielding element.

12. The electromagnet according to claim 1, wherein the shielding element has a material thickness ranging from 0.15 mm to 1.0 mm.

13. The electromagnet according to claim 1, further comprising a core, wherein a front end of the shielding element is arranged at a level of the core.

14. The electromagnet according to claim 1, further comprising a coil form, wherein a front end of the shielding element is arranged at a level of a longitudinal end of the coil form.

15. The electromagnet according to claim 1, further comprising a core and a coil form, wherein a front end of the shielding element is arranged at a level of the core and at a level of a longitudinal end of the coil form.

16. The electromagnet according to claim 1, wherein a front end of the shielding element forms an annular flange.

17. The electromagnet according to claim 16, wherein the annular flange extends radially inwards.

18. The electromagnet according to claim 16, wherein the annular flange extends radially outwards.

19. The electromagnet according to claim 1, further comprising a pole tube delimiting an armature space, wherein the armature is arranged in the armature space of the pole tube.
